(19) United States
(12) Patent Application Publication
(10) Pub. No.: US 2025/0199680 A1
(43) Pub. Date: Jun. 19, 2025

(54) CONTROLLER, STORAGE DEVICE, HOST DEVICE AND COMPUTING SYSTEM

(71) Applicant: SK hynix Inc., Icheon-si (KR)

(72) Inventors: Ki Young KIM, Icheon-si (KR); Jin Woo KIM, Icheon-si (KR)

(21) Appl. No.: 18/624,729

(22) Filed: Apr. 2, 2024

(30) Foreign Application Priority Data
Dec. 15, 2023 (KR) 10-2023-0182527

(51) Int. Cl. G06F 3/06

(52) U.S. Cl. CPC G06F 3/0604; G06F 3/064; G06F 3/0656; G06F 3/0679

(57) ABSTRACT

In an embodiment of the disclosed technology, file type information and file size information are provided through an extra header segment of a command unit and a file mapping table based on the file type information and the file size information is generated and managed. Therefore, by loading in advance an address mapping table associated with a file configured by read-requested data upon a read request, the performance of a read operation based on a mapping table may be improved.

### CROSS-REFERENCE TO RELATED APPLICATION

The present application claims priority under 35 U.S.C. § 119(a) to Korean Patent Application No. 10-2023-0182527 filed in the Korean Intellectual Property Office on Dec. 15, 2023, which is incorporated herein by reference in its entirety.

### BACKGROUND

### 1. Technical Field

Various embodiments of the disclosed technology generally relate to a controller, a storage device, a host device and a computing system.

### 2. Related Art

A storage device may include a memory including a plurality of memory cells that store data. The storage device may include a controller that controls the operation of the memory. The controller may control an operation of writing data to the memory, or reading or erasing data written to the memory.

For example, the controller may control the operation of the memory according to a command received from a host device.

The controller may perform an operation according to a command from the host device while managing the mapping relationship between a logical block address received from the host device and a physical block address of the memory using a mapping table. The controller may use the mapping table by loading it into a buffer memory.

While the controller loads mapping data and performs control according to a command, the buffer memory may have limitations in storage space and as a result the operational performance of the storage device may deteriorate.

### SUMMARY

Various embodiments of the disclosed technology are directed to providing measures capable of improving the operational performance of a storage device by improving the operational efficiency of a controller controlling the operation of a memory by using a mapping table representing the mapping relationship between a logical block address of a host device and a physical block address of the memory.

In an embodiment, a storage device may include: at least one memory; and a controller configured to control an operation of the at least one memory, to receive, from a host device, a command unit including an extra header segment in which file type information and file size information are included, to generate a file mapping table based on the file type information and the file size information and to store the file mapping table in the at least one memory.

In an embodiment, a controller may include: a buffer memory; and a processor configured to receive, from a host device, a command unit including an extra header segment in which file type information and file size information are included, and to set a file mapping table based on the file type information and the file size information.

In an embodiment, a computing system may include: a host device configured to transmit a command unit including an extra header segment in which file type information and file size information are included; and a storage device configured to receive the command unit from the host device, and to generate and store a file mapping table based on the file type information and the file size information.

In an embodiment, a host device may include: a command unit generator configured to generate a command unit including a data segment which includes a logical block address and data length information and an extra header segment which includes file type information and file size information; and a command unit transmitter configured to transmit the command unit to an outside.

According to the embodiments of the disclosed technology, by improving a method of loading mapping data according to a command received from a host device, it is possible to improve the operational performance of a controller which controls the operation of a storage device using the mapping data.

### BRIEF DESCRIPTION OF THE DRAWINGS

FIG. 1 is a diagram illustrating a schematic configuration of a storage device according to an embodiment of the disclosure.

FIG. 2 is a diagram illustrating a method of operation of a storage device when receiving a write command unit according to an embodiment of the disclosure.

FIG. 3 is a diagram illustrating examples of write command units received by a storage device according to embodiments of the disclosure.

FIG. 4 is a diagram illustrating an extra header segment included in a write command unit that is received by a storage device according to embodiments of the disclosure.

FIGS. 5 and 6 are diagrams illustrating examples of a method of generating a file mapping table according to a write command unit received by a storage device according to embodiments of the disclosure.

FIG. 7 is a diagram illustrating a method of operating a storage device that receives a read command unit according to an embodiment of the disclosure.

FIG. 8 is a diagram illustrating an extra header segment included in a read command unit received by a storage device according to an embodiment of the disclosure.

FIGS. 9 and 10 are diagrams illustrating methods of loading mapping data when a storage device receives a read command unit according to embodiments of the disclosure.

### DETAILED DESCRIPTION

In the following description of examples or embodiments of the present disclosure, reference will be made to the accompanying drawings in which it is shown by way of illustration specific examples or embodiments that can be implemented, and in which the same reference numerals and signs can be used to designate the same or like components even when they are shown in different accompanying drawings from one another. Further, in the following description of examples or embodiments of the present disclosure, detailed descriptions of well-known functions and components incorporated herein will be omitted when it is determined that the description may make the subject matter in some embodiments of the present disclosure rather unclear. The terms such as “including”, “having”, “containing”, “constituting” “made up of”, and “formed of” used herein are generally intended to allow other components to be added unless the terms are used with the term “only”. As used herein, singular forms are intended to include plural forms unless the context clearly indicates otherwise.

Terms, such as “first”, “second”, “A”, “B”, “(A)”, or “(B)” may be used herein to describe elements of the present disclosure. Each of these terms is not used to define essence, order, sequence, or number of elements etc., but is used merely to distinguish the corresponding element from other elements.

When it is mentioned that a first element “is connected or coupled to”, “contacts or overlaps”, etc., a second element, it should be interpreted that, not only can the first element “be directly connected or coupled to” or “directly contact or overlap” the second element, but a third element can also be “interposed” between the first and second elements, or the first and second elements can “be connected or coupled to”, “contact or overlap”, etc. each other via a fourth element. Here, the second element may be included in at least one of two or more elements that “are connected or coupled to”, “contact or overlap”, etc. each other.

When time relative terms, such as “after,” “subsequent to,” “next,” “before,” and the like, are used to describe processes or operations of elements or configurations, or flows or steps in operating, processing, manufacturing methods, these terms may be used to describe non-consecutive or non-sequential processes or operations unless the term “directly” or “immediately” is used together.

In addition, when any dimensions, relative sizes etc. are mentioned, it should be considered that numerical values for elements or features, or corresponding information (e.g., level, range, etc.) include a tolerance or error range that may be caused by various factors (e.g., process factors, internal or external impact, noise, etc.) even when a relevant description is not specified. Further, the term “may” fully encompasses all the meanings of the term “can”.

Hereinafter, various embodiments of the present disclosure will be described in detail with reference to accompanying drawings.

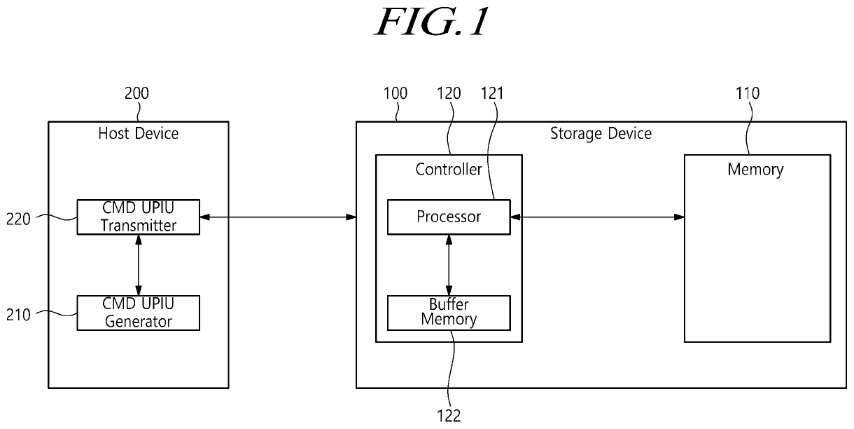

FIG. 1 is a diagram illustrating a schematic configuration of a storage device according to an embodiment of the disclosure.

Referring to FIG. 1, a storage device 100 may include a memory 110. The storage device 100 may include a controller 120, which controls the operation of the memory 110.

The memory 110 may be a nonvolatile memory. For example, the memory 110 may be implemented into various types of memory such as a NAND flash memory, a 3D NAND flash memory, a NOR flash memory, a resistive random access memory, a phase-change random access memory, a magnetoresistive random access memory, a ferroelectric random access memory and a spin transfer torque random access memory. The memory 110 may be implemented in a three-dimensional array structure. Embodiments of the disclosure may be applied not only to a flash memory in which a charge storage layer is configured by a floating gate, but also to a charge trap flash in which a charge storage layer includes an insulating film.

The memory 110 may operate in response to control of the controller 120. Operations of the memory 110 may include, for example, a program operation (also referred to as a “write operation”), an erase operation and a read operation.

The controller 120 may control program, erase, read and background operations that use the memory 110. Background operations may include, for example, at least one from among garbage collection, wear leveling, read reclaim and bad block management operations.

The controller 120 may control the operation of the memory 110 according to a request of a device located outside the storage device 100. The controller 120 may also control the operation of the memory 110 regardless, or in the absence, of a request from outside the storage device 100.

For example, the controller 120 may control the operation of the memory 110 according to a request of a host device 200. The storage device 100 and the host device 200 may be collectively referred to as a computing system.

For example, the host device 200 may be a computer, an ultra mobile PC (UMPC), a workstation, a personal digital assistant (PDA), a tablet, a mobile phone, a smartphone, an e-book, a portable multimedia player (PMP), a portable game player, a navigation device, a black box, a digital camera, a digital multimedia broadcasting (DMB) player, a smart television, a digital audio recorder, a digital audio player, a digital picture recorder, a digital picture player, a digital video recorder, a digital video player, a storage configuring a data center, one of various electronic devices configuring a home network, one of various electronic devices configuring a telematics network, an RFID (radio frequency identification) device, a mobility device (e.g., a vehicle, a robot or a drone) capable of driving under human control or autonomous driving, or the like. Alternatively, the host device 200 may be a virtual/augmented reality device that provides a 2D or 3D virtual reality image or augmented reality image. The host device 200 may be any one of various electronic devices each of which requires a storage device 100 capable of storing data.

The host device 200 may include at least one operating system. The operating system may manage and control overall functions and operations of the host device 200, and may control interoperations between the host device 200 and the storage device 100. The operating system may be classified into a general operating system and a mobile operating system depending on the mobility of the host device 200.

For example, the host device 200 may include a command unit (CMD UPIU (UFS Protocol Information Unit)) generator 210 and a command unit (CMD UPIU) transmitter 220.

The command unit generator 210 and the command unit transmitter 220 may be processing units that are implemented as a single chip or separate chips. Alternatively, each of the command unit generator 210 and the command unit transmitter 220 may be a component corresponding to at least any one of a translation layer, a data link layer and a physical layer that configure the host device 200.

The command unit generator 210 may generate a command unit to be transmitted to the storage device 100.

The command unit may be, for example, a write command unit, a read command unit, or the like. A command unit may include, for example, a header segment and a data segment, and the command unit may include an extra header segment.

The command unit generator 210 may provide information related to a command associated with the operation of the storage device 100, through various fields included in the header segment, the data segment and the extra header segment.

The command unit transmitter 220 may transmit the command unit generated by the command unit generator 210 to the storage device 100. The command unit transmitter 220 may receive various signals and data transmitted by the storage device 100.

The controller 120 and the host device 200 may be devices that are separated from each other. In some cases, the controller 120 and the host device 200 may be implemented by being integrated into one device. Hereunder, for the sake of convenience in explanation, examples will describe the controller 120 and the host device 200 as devices that are separated from each other.

The controller 120 may include a host interface that provides an interface for communication with the host device 200. The controller 120 may include a memory interface that provides an interface for communication with the memory 110.

The controller 120 may include a control circuit that controls overall operations of the controller 120. The control circuit may include a processor 121 as illustrated in FIG. 1. The control circuit may include a working memory that is used for the operation of the processor 121, and may optionally include an error detection and correction circuit.

The processor 121 may communicate with the host device 200 through the host interface, and may communicate with the memory 110 through the memory interface.

The processor 121 may interpret commands inputted from the host device 200 and transfer the commands to the memory 110.

For example, the processor 121 may include a flash translation layer or may correspond to a flash translation layer. The processor 121 may translate a logical block address provided by the host device 200 into a physical block address. The processor 121 may receive a logical block address and translate the logical block address into a physical block address using a mapping table.

The processor 121 may control the operation of the controller 120 by executing, for example, firmware. In some embodiments, an operation of the storage device 100 may be implemented so that the processor 121 executes firmware in which the corresponding operation is defined.

Firmware, as a program to be executed in the storage device 100 to drive the storage device 100, may include various functional layers corresponding to the processor 121 described above. For example, the firmware may include binary data in which codes for executing the respective functional layers are defined.

For example, the firmware may be loaded into the working memory from the memory 110 or a separate nonvolatile memory (e.g., a ROM or a NOR Flash) located outside the memory 110. When executing a booting operation after power-on, the processor 121 may first load all or a part of the firmware into the working memory.

In order to control overall operations of the controller 120, the processor 121 may perform a logic operation that is defined in the firmware loaded into the working memory. According to a result of performing the logic operation defined in the firmware, the processor 121 may control the controller 120 to generate a command or a signal. When a part of firmware in which a logic operation to be performed is defined is not loaded into the working memory, the processor 121 may generate an event (e.g., an interrupt) for loading the corresponding part of the firmware into the working memory.

The working memory may store firmware, program codes, commands or data necessary to drive the controller 120. The working memory may be located inside or outside the controller 120. Working memories may be located inside and outside the controller 120.

The working memory may be a buffer memory 122 illustrated in FIG. 1. Alternatively, the working memory may be disposed separately from the buffer memory 122 illustrated in FIG. 1. FIG. 1 illustrates a buffer memory 122 is located inside the controller 120, but the buffer memory 122 may also be located inside or outside the controller 120.

The working memory or the buffer memory 122 may be, for example, a volatile memory that includes at least one from among an SRAM (static RAM), a DRAM (dynamic RAM) and an SDRAM (synchronous DRAM).

The processor 121 of the controller 120 may control the operation of the memory 110 according to a command received from the host device 200.

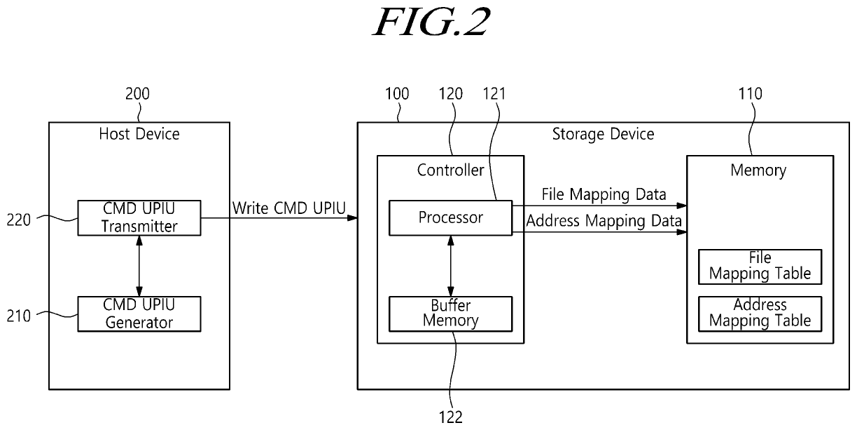

FIG. 2 is a diagram illustrating a method of operation of a storage device when receiving a write command unit according to an embodiment of the disclosure.

Referring to FIG. 2, a command unit generator 210 of a host device 200 may generate a write command unit Write CMD UPIU.

The write command unit Write CMD UPIU may include, for example, a logical block address and data length information. The logical block address and the data length information may be included in fields of a data segment included in the write command unit.

The write command unit may include file type information associated with data to be written. The file type information may be information indicating a file type such as image, video and metadata.

The write command unit may include file size information. The file size information may be information indicating the size of a file according to the file type information. The file size information may be information corresponding to a size equal to or larger than a data length according to the data length information included in the write command unit.

For example, the file type information and the file size information may be included in fields of an extra header segment included in the write command unit. Alternatively, at least one of the file type information and the file size information may be included in a field included in a segment other than the extra header segment.

The command unit generator 210 may generate the write command unit, which includes the file type information and the file size information in addition to the logical block address and the data length information.

A command unit transmitter 220 may transmit the write command unit generated by the command unit generator 210 to a storage device 100.

A controller 120 of the storage device 100 may receive the write command unit transmitted from the host device 200.

The controller 120 may check, from the write command unit, the length of the data to be written, and may transmit a data transmission request to the host device 200 when preparation for writing the data is completed. The controller 120 may receive the data from the host device 200, which has received the data transmission request, and may write the received data to the memory 110.

The controller 120 may generate a mapping table for managing the data to be written to the memory 110. The controller 120 may store the mapping table in the memory 110. The controller 120 may generate a plurality of mapping tables according to information to be managed and store the plurality of mapping tables in the memory 110.

The controller 120 may generate an address mapping table on the basis of the logical block address included in the write command unit received from the host device 200. The address mapping table may include the mapping relationship between the logical block address provided by the host device 200 and a physical block address of the memory 110 at which the corresponding data is to be written.

The controller 120 may generate the address mapping table and store the address mapping table in the memory 110. The controller 120 may control a read operation for the data stored in the memory 110 using mapping data included in the address mapping table.

The controller 120 may generate a file mapping table on the basis of the file type information and the file size information included in the write command unit received from the host device 200.

The controller 120 may categorize the file type of the data to be written using the file type information provided by the write command unit. The controller 120 may manage the mapping relationship of the data categorized using the file type and the file size information.

For example, the file size information may be information indicating the size of a file that includes the data to be written according to the write command unit. The data to be written may correspond to a part of the file according to the file type information included in the write command unit.

The controller 120 may generate the file mapping table according to the file type and the file size of the corresponding data, separately from the address mapping table based on the physical block address at which the data according to the write command unit is to be written. The controller 120 may store and manage the file mapping table in the memory 110.

The controller 120 may control the operation of reading the data written to the memory 110 by using the file mapping table stored in the memory 110 together with the address mapping table.

The controller 120 may receive the file type information and the file size information through the extra header segment included in the write command unit. The file type information and the file size information may be transferred through the extra header segment in various ways.

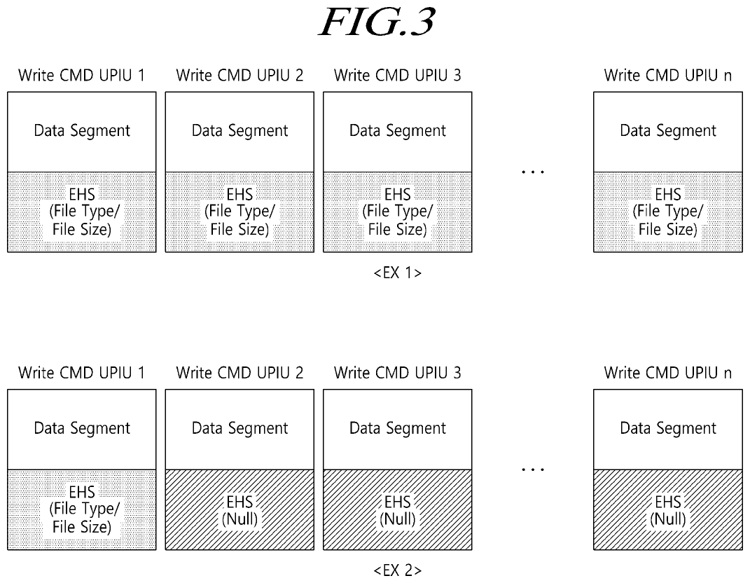

FIG. 3 is a diagram illustrating examples of write command units that are received by a storage device according to embodiments of the disclosure.

For example, referring to <EX 1> in FIG. 3, an n number of write command units are transmitted. The n number of write command units may be write command units that are transmitted to write data that configures one file.

A host device 200 may provide a logical block address and data length information to the storage device 100 through fields of a data segment included in each write command unit.

The host device 200 may provide file type information and file size information to the storage device 100 through fields of an extra header segment EHS included in each write command unit.

For example, the host device 200 may transmit file type information and file size information through extra header segments included in every write command unit related to the data that configures the corresponding file. In some examples, the file type information and the file size information transferred through the extra header segments of the write command units associated with the data configuring one file may be the same.

Alternatively, referring to <EX 2> of FIG. 3, the host device 200 may provide file type information and file size information to the storage device 100 through an extra header segment included in any one write command unit from among an n number of write command units that request writing data that configures one file.

For example, the file type information and the file size information may be provided through an extra header segment included in a first write command unit among the n number of write command units.

Thus, in FIG. 3, extra header segments included in the remaining write command units of the n number of write command units may not include file type information and file size information.

In the above examples <EX 1> and <EX 2>, the controller 120 of the storage device 100 may generate a file mapping table by checking the file type information and the file size information included in the respective extra header segments of the n number of write command units associated with all of the data that configures the one file, or the extra header segment of any one of the n number of write command units, and may store and manage the file mapping table in the memory 110.

The file type information and the file size information are transferred through fields included in the extra header segment in various ways.

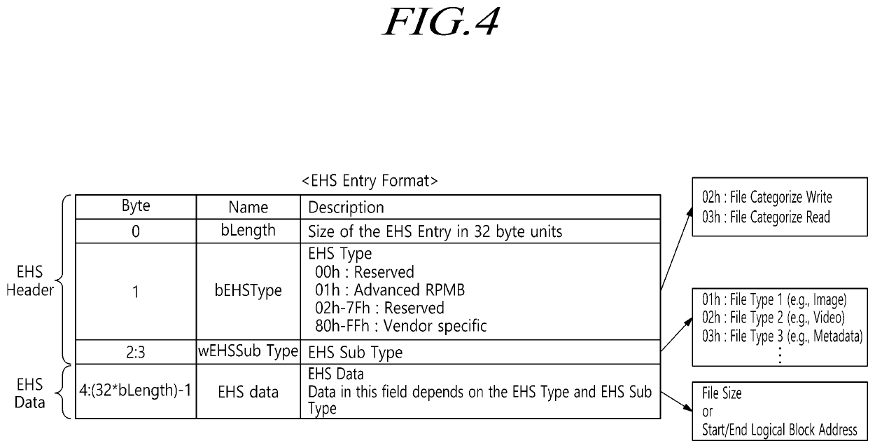

FIG. 4 is a diagram illustrating an extra header segment included in a write command unit that is received by a storage device according to embodiments of the disclosure.

For example, referring to FIG. 4, an extra header segment may include a header portion and a data portion.

File type information may be transmitted through any one of fields included in the header portion of the extra header segment (EHS Header).

The file type information may be provided through, for example, an EHS Sub Type field. The file type information may be provided as, for example, 01h, 02h, 03h, etc. to correspond to file types such as image, video, metadata, etc.

File size information may be transmitted through a field included in the data portion of the extra header segment.

The file size information may be provided through, for example, an EHS data field. The file size information may be transferred as information indicating a file size, or may be transferred as information on a start logical block address and an end logical block address corresponding to a file.

At least one information in addition to the file type information and the file size information may be transferred through the extra header segment.

For example, information that categorizes write or read may be provided through an EHS Type field included in the header portion of the extra header segment. The information that categorizes write or read in the EHS Type field may be expressed using a reserved value. In the EHS Type field, write or read may be indicated using a value other than 01h, which is used for an advanced RPMB (replay protected memory block). For example, write may be indicated using 02h from among reserved values and read may be indicated using 03h, but embodiments of the disclosed technology are not limited thereto.

The controller 120 of the storage device 100 may perform an operation based on the file type information depending on whether a command unit is a write command unit or a read command unit, but may also perform an operation using the file type information on the basis of information included in the EHS Type field included in the extra header segment.

When information included in the EHS Type field of the extra header segment indicates a write command, the controller 120 may generate a file mapping table on the basis of the file type information included in the EHS Sub Type field and the file size information included in the EHS data field. The controller 120 may store and manage the file mapping table in the memory 110.

The controller 120 may generate a file mapping table in various forms. For example, the controller 120 may generate a file mapping table in the form of a tree mapping table.

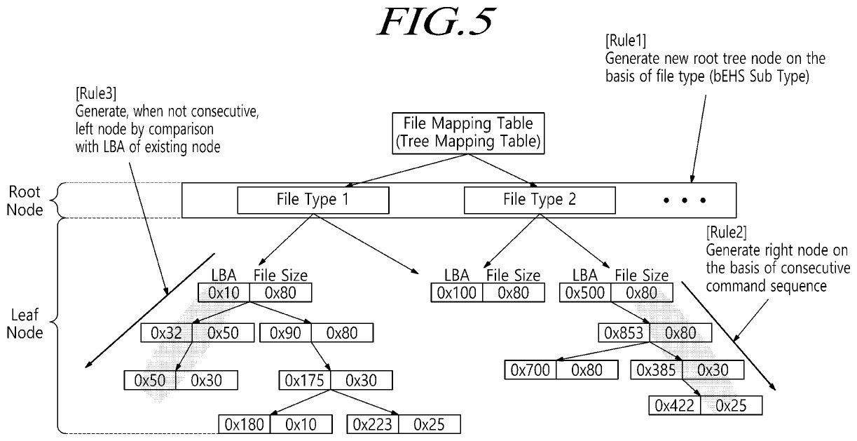

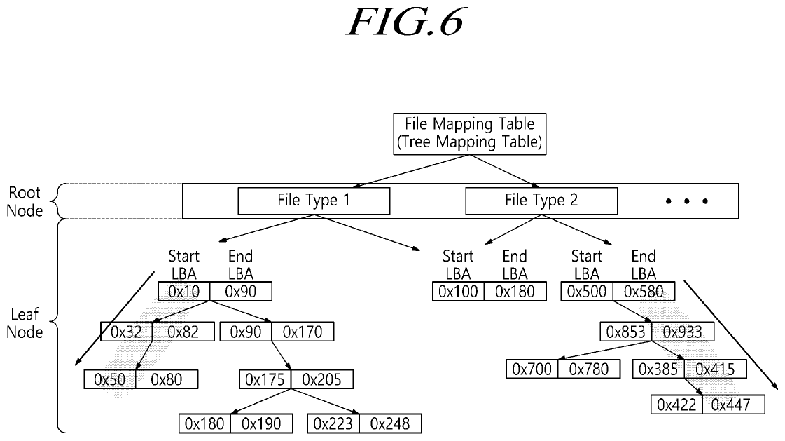

FIGS. 5 and 6 are diagrams illustrating examples of a method of generating a file mapping table according to a write command unit received by a storage device according to embodiments of the disclosure.

Referring to FIGS. 5 and 6, a controller 120 may generate a file mapping table using file type information and file size information included in an extra header segment. Alternatively, the controller 120 may generate a file mapping table using file type information and file size information included in an extra header segment and a logical block address included in a data segment.

The controller 120 may set a root node on the basis of a file type information (Rule1). The controller 120 may set and manage information, on a file of the same type, as a leaf node of the root node based on the file type information.

The controller 120 may set leaf nodes based on the file size information included in consecutive write command units including the same file type information, as first (e.g., right) nodes (Rule2).

For example, referring to a tree mapping table with a file type 2 as a root node, file size information corresponding to logical block addresses 0x500, 0x853, 0x385 and 0x422 may be received through consecutive write command units. Leaf nodes based on file size information received through consecutive write command units may be set as right nodes of a root node or of leaf nodes.

When receiving a non-consecutive write command unit, the controller 120 may compare a logical block address according to the write command unit with the logical block address of an existing leaf node, and may set a second (e.g., left) node of the existing leaf node (Rule3).

For example, referring to the tree mapping table with the file type 2 as a root node, since a logical block address 0x100 included in a non-consecutive write command unit is less than 0x500, the logical block address 0x100 may be set as a left node at the same level as a leaf node for 0x500. Further, because a logical block address 0x700 is less than 0x853, the logical block address 0x700 may be set as a left node at the same level as a leaf node for 0x853.

The controller 120 may generate a file mapping table while setting a leaf node according to file size information, depending on whether a write command unit is included in consecutive write command units and on positional relationships according to relationships in size of a logical block address.

A leaf node included in a file mapping table may be configured in various ways. For example, as illustrated in FIG. 5, a leaf node may be configured with a logical block address and file size information. The logical block address may be a logical block address included in the data segment of a write command unit, or may be a start logical block address in file size information included in the extra header segment.

Alternatively, as in an example illustrated in FIG. 6, a leaf node may be configured with a start logical block address and an end logical block address. The start logical block address may be information corresponding to a logical block address illustrated in FIG. 5. File size information may be calculated on the basis of the difference between the start logical block address and the end logical block address.

Methods of configuring a leaf node are not limited to the above-described examples, and a leaf node may be configured in various ways by using at least a part of file type information and file size information transmitted through the extra header segment of a write command unit and a logical block address transmitted through the data segment.

A file may be categorized according to file type information. The start logical block address and the file size information of a file type are associated with data corresponding to the file. The start logical block address and file size information corresponding to each file and file type may be provided through a file mapping table.

Since it is possible to check the logical block addresses of a plurality of data corresponding to each file through a file mapping table, when controlling the read operation of the controller 120 according to a command of the host device 200, the efficiency of the read operation may be increased by loading mapping data in advance.

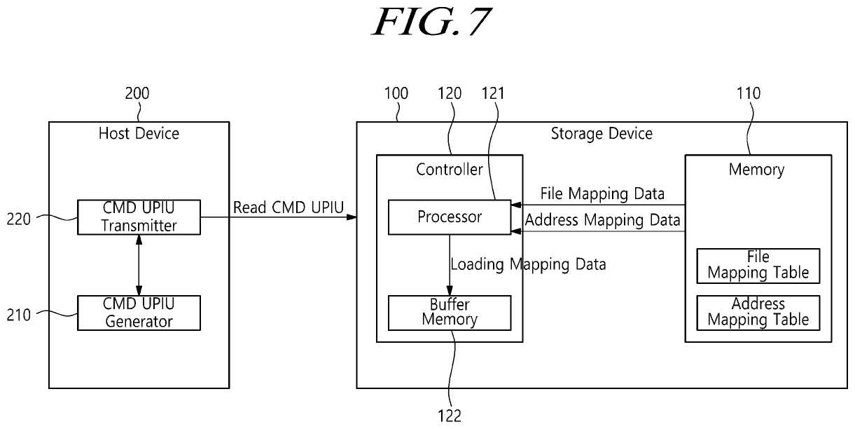

FIG. 7 is a diagram illustrating a method of operating a storage device that receives a read command unit according to an embodiment of the disclosure.

Referring to FIG. 7, a command unit generator 210 of the host device 200 may generate a read command unit. The read command unit Read CMD UPIU may include, for example, file type information. The read command unit may include file size information. The file type information and the file size information may be included in fields of an extra header segment included in the read command unit.

A command unit transmitter 220 may transmit the read command unit to a storage device 100.

A controller 120 of the storage device 100 may perform a read operation according to the read command unit. In order to perform the read operation, the controller 120 may load a mapping table stored in a memory 110 into a buffer memory 122 included in the controller 120.

For example, the controller 120 may load at least a portion of file mapping data included in a file mapping table into the buffer memory 122. The controller 120 may load at least a portion of address mapping data included in an address mapping table into the buffer memory 122.

The controller 120 may load the address mapping data on the basis of a logical block address included in the read command unit. The controller 120 may read data according to the read command unit on the basis of the loaded address mapping data and provide the read data to the host device 200.

The controller 120 may load the file mapping data on the basis of at least one of the logical block address included in the read command unit and the file type information and file size information included in the extra header segment of the read command unit.

The controller 120 may use the file mapping data to determine the address mapping data to be loaded according to the read command unit.

By controlling the loading of the address mapping data using the file mapping data, the controller 120 may improve the performance of the read operation according to the read command unit.

The controller 120 may load, on the basis of the logical block address included in the read command unit, the file mapping data including the corresponding logical block address into the buffer memory 122.

Alternatively, the controller 120 may determine the file mapping data to be loaded into the buffer memory 122, on the basis of the file type information and file size information included in the extra header segment of the read command unit.

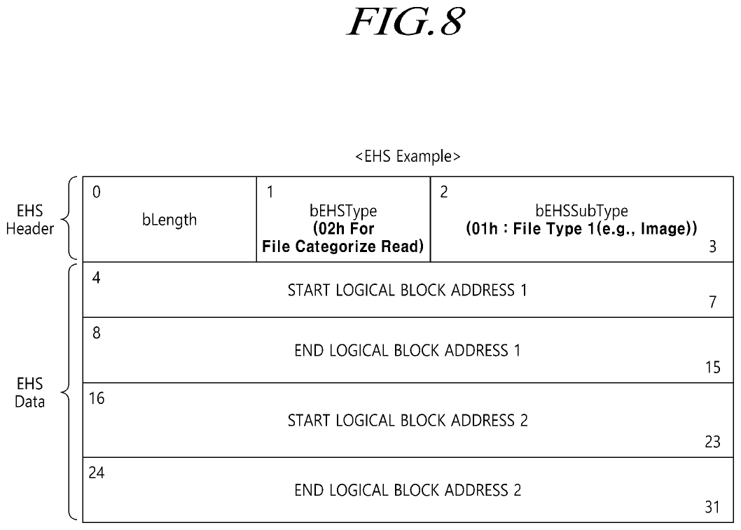

FIG. 8 is a diagram illustrating an extra header segment included in a read command unit received by a storage device according to an embodiment of the disclosure.

Referring to FIG. 8, an extra header segment included in the read command unit may include a header portion and a data portion. File type information may be provided through an EHS Sub Type field of the header portion of the extra header segment. Information indicating a write or read command may be provided through an EHS Type field of the header portion of the extra header segment.

For example, a value of 02h indicating read may be transmitted through the EHS Type field. A value of 01h indicating a file type may be transmitted through the EHS Sub Type field. The value of 01h may indicate an image file.

File size information may be transmitted through an EHS data field of the data portion of the extra header segment. FIG. 8 illustrates an example a case where the file size information is transmitted as a start logical block address and an end logical block address. The file size information transferred through the EHS data field may be for one or a multitude of start and end logical block addresses. FIG. 8 illustrates two file size information transmitted through the EHS data field. A plurality of file size information for the same type of file may be transferred through the EHS data field of one extra header segment.

The controller 120 may check a file type through the file type information included in the extra header segment.

The controller 120 may check a start logical block address for a corresponding file on the basis of the file size information included in the extra header segment. In addition, the controller 120 may check the range of logical block addresses for the corresponding file on the basis of the file size information.

The controller 120 may check the file associated with data requested by the read command unit on the basis of the file type information and file size information included in the extra header segment. The controller 120 may check data configuring the corresponding file, and may improve the performance of the read operation by loading in advance the address mapping table for the corresponding data.

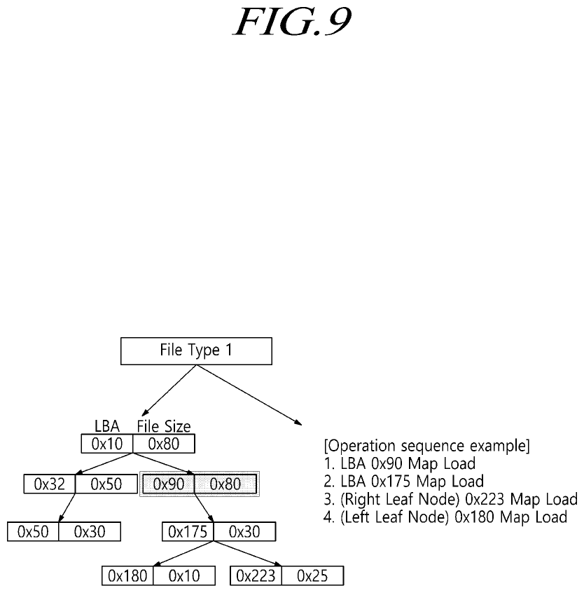

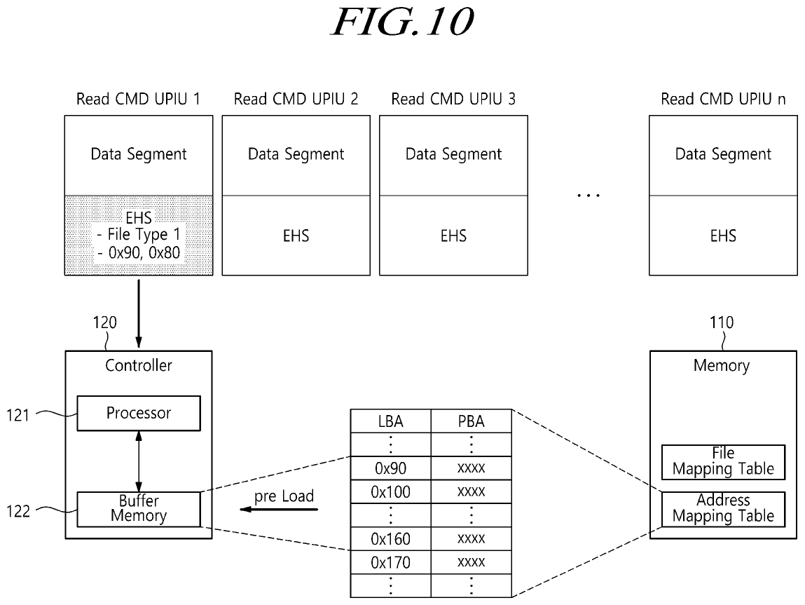

FIGS. 9 and 10 are diagrams illustrating a method of loading mapping data when a storage device receives a read command unit according to embodiments of the disclosure.

Referring to FIG. 9, a storage device 100 may check the file type of read-requested data and a logical block address for the data, on the basis of information included in a read command unit received from the host device 200.

For example, the controller 120 of the storage device 100 may check the file type of the read-requested data on the basis of file type information included in the extra header segment of the read command unit. FIG. 9 illustrates a file type 1 of read-requested data according to the read command unit.

The controller 120 may check a logical block address for a file related to the read-requested data, by using a logical block address included in the data segment of the read command unit. Alternatively, the controller 120 may check a logical block address for a file related with to read-requested data, on the basis of file size information included in the extra header segment of the read command unit. FIG. 9 illustrates a read-requested file according to the read command unit that corresponds to a logical block address 0x90 of the file type 1.

The controller 120 may check 0x90 by the logical block address included in the data segment of the read command unit, or may check 0x90 through the EHS data field of the extra header segment.

The controller 120 may load an address mapping data corresponding to the logical block address 0x90 into the buffer memory 122 on the basis of the checked file type information and file size information. Since a read request for data corresponding to the logical block address 0x90 of the file type 1 is received, the controller 120 may load in advance address mapping data related to data configuring the corresponding file into the buffer memory 122.

The controller 120 may load address mapping data related to a file received consecutively to the file corresponding to the logical block address 0x90.

For example, the controller 120 may load address mapping data corresponding to a logical block address 0x175 and a logical block address 0x223 corresponding to right nodes of a leaf node corresponding to the logical block address 0x90. Thereafter, the controller 120 may load address mapping data corresponding to a logical block address 0x180 corresponding to a left node of the leaf node corresponding to the logical block address 0x175.

The controller 120 may load in advance, into the buffer memory 122, address mapping data associated with the data configuring the file including the read-requested data, on the basis of the file type information and file size information received through the extra header segment of the read command unit. Before receiving the read command unit including the logical block address included in the address mapping data, the corresponding address mapping data may be loaded into the buffer memory 122, and the efficiency of the read operation may be improved.

In FIG. 10, a storage device 100 receives n number of read command units from a host device 200. The n number of read command units may be commands that request reading of data configuring one file.

The host device 200 may transmit file type information and file size information associated with the read-requested data, through an extra header segment included in at least one of the n number of read command units. The host device 200 may transmit file type information and file size information through all extra header segments included in the n number of read command units, or may transmit file type information and file size information through an extra header segment included in a first read command unit.

When receiving a read command unit from the host device 200, the controller 120 of the storage device 100 may check file type information and file size information through an extra header segment.

Based on a file mapping table stored in the memory 110, the controller 120 may check the file type of the read-requested data and the range of logical block addresses in which the file configured by the corresponding data is stored.

For example, when the start logical block address of the file size information included in the extra header segment is 0x90 and the file size information is 0x80, the controller 120 may check that the file configured by the read-requested data is stored in a physical block address corresponding to logical block addresses 0x90 to 0x160.

Before receiving a read command unit that requests reading of another data configuring the corresponding file, the controller 120 may load in advance, on the basis of a checked logical block address, address mapping data related with the corresponding logical block address into the buffer memory 122.

Since address mapping data associated with a file configured by read-requested data is loaded in advance into the buffer memory 122, the performance of a read operation according to a read request of the host device 200 may be improved.

As is apparent from the above description, in embodiments of the disclosed technology, since a file mapping table is generated and managed on the basis of file type information and file size information received through the extra header segment of a write command unit, the loading speed of an address mapping table associated with read-requested data in a read operation may be improved, and thus, the efficiency of the read operation may be improved.

In addition, when considering that data configuring one file may be read or erased together, data to be moved may be selected using the file mapping data of the file mapping table when performing a background operation such as garbage collection or wear leveling, and thus, the efficiency of the background operation may be increased.

Although various embodiments of the disclosed technology have been described with particular specifics and varying details for illustrative purposes, those skilled in the art will appreciate that various modifications, additions and substitutions may be made based on what is disclosed or illustrated in the disclosed technology without departing from the spirit and scope of the disclosed technology as defined in the following claims.

What is claimed is:

1. A storage device comprising:
at least one memory; and
a controller configured to control an operation of the at least one memory, to receive, from a host device, a command unit including an extra header segment in which file type information and file size information are included, to generate a file mapping table based on the file type information and the file size information and to store the file mapping table in the at least one memory.

2. The storage device according to claim 1, wherein the file type information is included in a header portion of the extra header segment.

3. The storage device according to claim 2, wherein the header portion of the extra header segment includes a first header field that includes a value indicating write or read and a second header field that includes the file type information.

4. The storage device according to claim 3, wherein the value indicating the write or the read in the first header field included in the header portion is a value other than 01h.

5. The storage device according to claim 1, wherein the file size information is included in a data portion of the extra header segment.

6. The storage device according to claim 1, wherein, when the command unit is a write command unit, the controller generates or updates the file mapping table while setting a root node based on the file type information and setting a leaf node based on the file size information.

7. The storage device according to claim 6, wherein the controller sets the leaf node based on a logical block address included in the write command unit and the file size information included in the extra header segment.

8. The storage device according to claim 1, wherein, when the command unit is a read command unit, the controller loads a plurality of address mapping data into a buffer memory from an address mapping table, including a mapping relationship between a logical block address provided by the host device and a physical block address of the at least one memory, by using the file mapping table.

9. The storage device according to claim 8, wherein at least one of the plurality of address mapping data is loaded into the buffer memory before receiving the read command unit including a logical block address corresponding to the at least one of the plurality of address mapping data from the host device.

10. The storage device according to claim 8, wherein the controller checks, in the file mapping table, the file size information corresponding to a logical block address included in the read command unit, and loads the plurality of address mapping data into the buffer memory from the address mapping table based on the logical block address and the file size information.

11. The storage device according to claim 8, wherein the controller checks the file size information included in the read command unit, and loads, into the buffer memory, the plurality of address mapping data included in a range corresponding to the file size information, from the address mapping table.

12. The storage device according to claim 8, wherein, when controlling a read operation on the at least one memory, the controller loads, into the buffer memory, at least one file mapping data according to the file mapping table and at least one address mapping data according to the address mapping table.

13. A controller comprising:
a buffer memory; and
a processor configured to receive, from a host device, a command unit including an extra header segment in which file type information and file size information are included, and to set a file mapping table based on the file type information and the file size information.

14. The controller according to claim 13, wherein the processor stores the file mapping table in an external memory, and stores an address mapping table based on a mapping relationship between a logical block address from the host device and a physical block address of the external memory, in the external memory.

15. The controller according to claim 14, wherein, when receiving a read command unit from the host device, the processor loads, into the buffer memory, at least one file mapping data included in the file mapping table and at least one address mapping data included in the address mapping table.

16. The controller according to claim 15, wherein the processor loads, into the buffer memory, the at least one address mapping data before receiving the read command unit including a logical block address that corresponds to the at least one address mapping data based on the at least one file mapping data.

17. A computing system comprising:
a host device configured to transmit a command unit including an extra header segment in which file type information and file size information are included; and
a storage device configured to receive the command unit from the host device, and to generate and store a file mapping table based on the file type information and the file size information.

18. The computing system according to claim 17, wherein, when the command unit is a write command unit, the storage device generates or updates the file mapping table based on a logical block address included in the write command unit and the file type information and the file size information included in the extra header segment.

19. The computing system according to claim 17, wherein, when the command unit is a read command unit, based on a logical block address included in the read command unit and the file mapping table, the storage device loads, into a buffer memory, address mapping data representing a mapping relationship between at least one logical block address other than the logical block address included in the read command unit and a physical block address.

20. The computing system according to claim 17, wherein, the host device is configured to generate and transmit the command unit including the extra header segment which includes a value indicating a write or a read in a first header field of a header portion, the file type information in a second header field of the header portion, and the file size information in a data portion.
